(19) United States
(12) Patent Application Publication
(10) Pub. No.: US 2011/0204093 A1
(43) Pub. Date: Aug. 25, 2011

(54) Wine Dispensing Device

(76) Inventor: Nathan Tyler Lee, Golden Valley, MN (US)

(21) Appl. No.: 13/017,007

(22) Filed: Jan. 30, 2011

Related U.S. Application Data
(60) Provisional application No. 61/306,506, filed on Feb. 21, 2010.

(51) Int. Cl. B67D 1/08

(52) U.S. Cl. 222/152

(57) ABSTRACT

A wine dispensing device for dispensing multiple portions of wine over a period of time while also providing preservation of the wine bouquet and taste character. The device couples to a wine bottle to allow wine to be dispensed through displacement with an inert gas. The device provides preservation of wine over multiple dispenses and over an extended period of time. In some embodiments the device dispenses wine without necessitating removal of the cork and can include an inert gas purge procedure to reduce wine exposure to atmospheric air thereby improving the quality and length of wine preservation that is possible.

### CROSS-REFERENCE TO RELATED APPLICATIONS

This application claims the benefit of U.S. Provisional application No. 61/306,506, filed on Feb. 21, 2010, which is herein incorporated by reference.

### FEDERALLY SPONSORED RESEARCH OR DEVELOPMENT

Not applicable.

### TECHNICAL FIELD

This disclosure relates to a device for dispensing a portion of wine from a wine bottle and providing for the preservation of the remaining wine within the bottle for dispensing at a later time.

### BACKGROUND

Upon opening a bottle of wine, the wine becomes exposed to the air/atmosphere and thus begins an immediate and complex reaction between the wine and the atmosphere. For many wines, a certain extent of reaction with air, known as aeration or allowing the wine to “breathe”, is a highly positive phenomenon known to help release aromas and smooth tannins on a wine drinker's palate. However, too much exposure of wine to air is well known to cause spoilage and eventual acidification of the wine.

To facilitate storage without spoilage, wine bottles, as well as bottles and containers for many other purposes, have traditionally utilized bottle closures that consist of a stopper from a natural material known as “barkcork” or simply “cork.” There have also been various synthetic “cork” substitutes that have been developed such as closed cell foam, thermoplastic elastomers, and other synthetic substitute materials that aim to address some of the limitations of natural corks. Recently, screw cap closures have been gaining acceptance as a closure method for bottled wine and have a number of practical advantages over stopper closures; e.g., they can be opened without any tools, eliminate cork taint, and they provide improved tamper evidence.

For wine consumers, when a new bottle of wine is opened and only a portion consumed, it is a common desire for the remainder of the bottle to be consumed at a later time. To the frequent wine drinker and especially for the connoisseur, even very minimal or short time duration contact between wine and air can impact wine bouquet and taste significantly, with some wines being especially sensitive to air contact. This has made the preservation of the remaining contents of an opened and partially-consumed bottle of wine a significant challenge. There have been a number of apparatuses and methods known in the art to preserve the remainder of a partially-consumed bottle of wine. A majority of commercially available wine preservation approaches focus on reducing the amount of contact of the wine with air. There is a great variation in the approach to solving this problem including creating vacuums, using specialty or inert gases (such as nitrogen or argon) to blanket the surface above the wine, and using pressurized inert gas to dispense the wine from the bottle, thereby minimizing the introduction of air. Many of the approaches tend to be effective for preservation for a day or two but commonly are limited by how many times additional wine is dispensed, since, for many of the approaches, during each dispensing procedure further air is allowed to contact and mix with the wine remaining in the container. This is a significant limitation for consumers that desire a single glass or a smaller portion over multiple dispenses, particularly if there are several days passing between each of said dispenses.

Some of the more effective wine preservation approaches have used a pressure head of specialty gas applied to the bottle contents to dispense the wine and thereby allow for multiple dispensing without further introductions of air. These approaches, while being significantly more effective than approaches that allow additional air contact and mixing at each dispense/pour, are not ideal, as they typically allow an initial contamination of atmosphere at the time the bottle cork (or other seal) is initially opened. The initial exposure with air at the time of bottle opening when the seal is removed can significantly limit the potential to preserve the wine for longer periods of time. This problem has been addressed by devices that use needles or other mechanisms to penetrate the cork and, in combination with pressurized gas, displace wine and thereby dispense it through the cork seal via the needle from the bottle. However, these approaches have generally been limited in their compatibility to bottles having a traditional barkcork stopper and typically don't work well with synthetic stoppers. There are also compatibility issues with bottles having the screw top closures that are gaining popularity for sealing wine bottles. Additionally, the approaches that penetrate the cork or stopper with a needle have the inherent operator risks associated with sharp needles or have been prohibitively difficult for a user to penetrate through the cork.

The as-claimed invention addresses some of these challenges and provides for an improved wine dispensing and preservation device.

### BRIEF DESCRIPTION OF DRAWINGS

Aspects and features of the as-claimed invention will be appreciated and better understood by reference to the detailed description of the embodiments of the invention when considered in connection with the accompanying drawings, wherein:

FIG. 1 is a perspective view of a wine dispensing device in accordance with one embodiment. The device is shown coupled with a wine bottle. The bottle is cut-away to show the device within the bottle.

FIG. 2 is a schematic of a wine dispensing device in a penetrating configuration, in preparation for coupling to a bottle having a cork.

FIG. 3 is a schematic of a wine dispensing device in a penetrating configuration wherein the device has penetrated through the cork and is thereby coupled to the bottle.

FIG. 4 is a schematic of a wine dispensing device coupled to a bottle having a cork. The device is illustrated in a dispensing configuration and showing gas delivery and dispensing flow of wine.

FIG. 5 is a schematic of a wine dispensing device coupled to a bottle wherein the bottle is of the variety not having a cork or where the cork was previously removed. The device is in a dispensing configuration and illustrates gas delivery and dispensing of wine.

FIG. 6 is a side view of a lower device assembly of a wine dispensing device.

FIG. 7 is a side view of an upper device assembly of a wine dispensing device.

FIG. 8 is a side view of a wine preservation and dispensing device shown in a penetration configuration.

FIG. 9 is a side view of a wine preservation and dispensing device shown in a dispensing configuration.

FIG. 10 is a section view showing section D-D from FIG. 6.

FIG. 11 is a section view showing section E-E from FIG. 7.

FIG. 12 is an enlarged perspective view of the upper and lower device components shown in a partially-open transition position.

FIG. 13 is an enlarged perspective view of the upper and lower device components shown in a penetration configuration that provide for a continuous screw thread.

FIG. 14 is an alternative embodiment schematic of a wine dispensing device in a position for delivering a pressurized gas to the bottle.

FIG. 15 is an alternative embodiment schematic of a wine dispensing device in a pouring position for delivering the beverage.

FIG. 16 is an alternative embodiment schematic of a wine dispensing device having a penetrating nosecone without screw threads.

### DETAILED DESCRIPTION

The accompanying drawings form part of the detailed description below. The drawings show illustrative embodiments in which the invention may be practiced, by way of example and not by way of limitation. These embodiments are described in a level of detail through the combination of text and drawing figures to enable those skilled in the art to practice the claimed invention. In the drawings, like numerals describe substantially similar components throughout the several views. The drawings illustrate generally, by way of example, but not by way of limitation, various embodiments discussed in this disclosure. The drawings are not necessarily drawn to scale and various schematics have components modified in their scale in order to aid in explaining various functional operations.

In reference to the drawings and throughout the detailed description and claims, reference will be made to direction including the terms “upper” or “upward,” and “lower” or “downward.” These directional designations apply to the as-claimed device relative to its interaction with a bottle and in further reference to when the bottle is in an upright configuration. As further clarification, the bottle or container is considered for descriptive purposes to be upright when the base end of the bottle (commonly the end also having a punt) is supporting the bottle and the bottle is in a vertical orientation where the neck and opening of the bottle is generally upward when compared with the opposite base end.

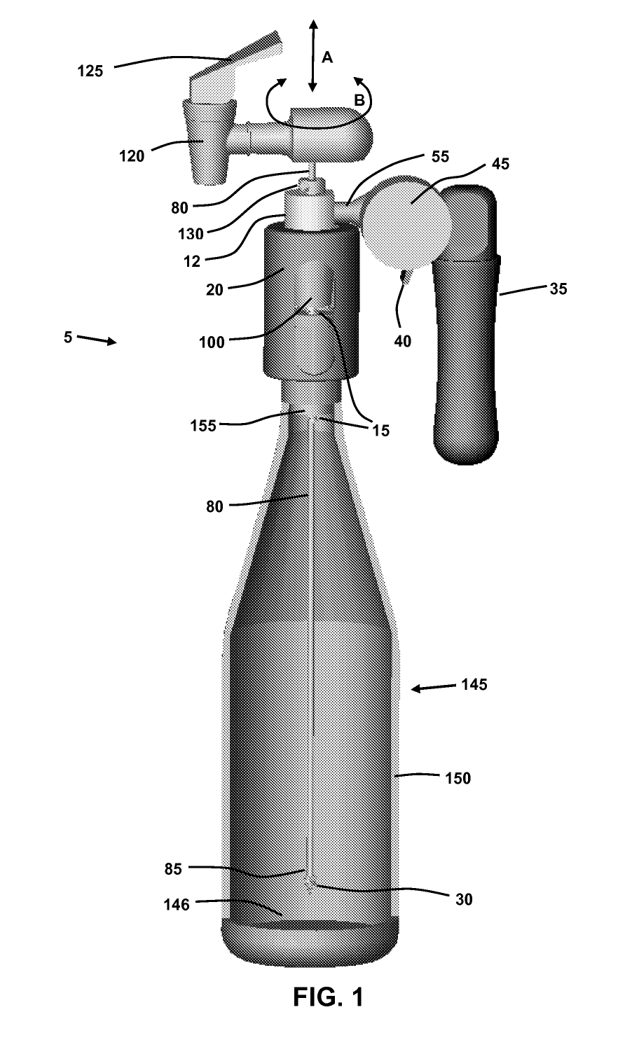

In reference to FIG. 1 and in accordance with one embodiment of the claimed invention, a perspective view of a wine dispensing and preservation device is shown coupled to a bottle 5. For clarity, the bottle 145 is shown with cut-out portion 150 removed, allowing for details of the device to be viewed. The device includes an upper assembly and a lower assembly (not called out in FIG. 1) that provide for axial movement A and rotational movement B relative to the assemblies in order that the device is able to assume a first configuration for penetration into a cork, and a second configuration for dispensing wine contained within the bottle. Given FIG. 1 shows the overall device from a high level, greater description of the device's functional configurations, the upper and lower assemblies, and other components will be reviewed in greater detail later in the detailed description and in other figures.

For now, FIG. 1 is shown in a dispensing configuration wherein the screw portion of the upper assembly 15 penetrates through a cork seal 155 of the bottle 145 and wherein a tube 80 that makes up part of the lower assembly extends towards the bottom of the bottle 146 and terminates with a nosecone 30. The tube 80 extends through a cylindrical opening within the upper assembly that includes the screw portion 15 and upper body portion 12. The tube 80 then passes through a collar 130 for selectively locking the upper and lower device assemblies relative each other, and terminates with a spigot 120 that houses a valve that is actuated by a handle 125 to dispense the beverage from the device.

The upper assembly of the device can optionally include a handle 20 to provide additional leverage to advance the device into and through the cork 155, as well as a stopper 100 that can be used as an alternative for coupling the device to the bottle 145 if the bottle does not have a cork 15; these features will be delved into with greater detail later in the specification. Optionally, the device can include a regulator assembly 35 that includes a gas source, such as a gas cartridge, the cartridge typically requiring reduction from a high pressure to a lower pressure by a regulator. The regulator provides lower pressure gas to be used by the device for the purpose of dispensing and preserving wine (not shown) from the bottle 145. The device can also optionally include a pressure-indicating gauge (or gauges) 45 that can indicate the pressure before regulator reduction and/or the pressure after regulator reduction. There are many different selectable valves that can be used to open the gas flow; a trigger 40 is used in this embodiment. Alternatively, the regulator assembly 35 can be a separate component that is coupled to the device, e.g., by a valved quick-disconnect coupling such as the PMC NSF series of valves supplied by the Colder Products Company of St. Paul, Minn. During a dispensing operation, gas enters the device at a connection 55 and passes into the bottle 150 through a lumen created by the space between the outer diameter of the tube 80 and the cylindrical opening within the upper assembly (not shown). Gas then enters the headspace of the bottle 150 where it provides a pressure head above the wine (not shown). When the valve in the spigot 120 is selectively opened, such as by means of handle 125, the pressure head from the gas within the bottle forces wine through an orifice 85 and into the tube 80. From within the tube 80, the wine travels upward and is dispensed from the device at a spigot 120 (or other valve). This sequence will be explained in greater detail below.

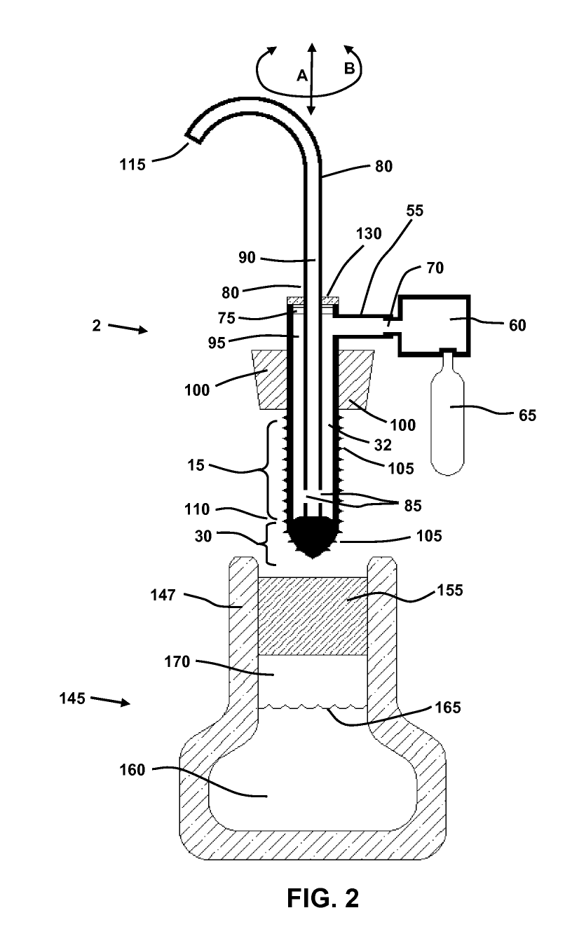

A series of schematics that conceptually illustrate operation of the embodiment of FIG. 1 through the phases of coupling with a bottle are shown in FIGS. 2-5. The schematics in these figures show cross-sectional views as would be seen if taken through the midline of a bottle and device. Features of the bottle and device are drawn purposely enlarged relative to other features to aid in understanding the operation and/or functional aspects of the embodiment. In FIGS. 2-4, the bottle 145 is of the variety having a cork 155 (or other stopper-type closure). The bottle is shown full of wine/beverage 160 where the liquid level 165 of the beverage 160 abuts a head space 170 in the neck area of the bottle (or thereabout). Wine bottles of the variety having a cork frequently have a foil, wax, or other covering material that protects the cork 155; for the purpose of operational illustration, no covering is shown in FIGS. 2-4. Stopper coverings could be optionally present, based on user preference and depending on device compatibility with the covering material; or such coverings may need to be removed prior to engagement with the device.

Beginning with FIG. 2, the wine dispensing device is shown in a penetrating configuration 2 for preparation to couple to a bottle 145. In the penetrating configuration, the device provides for a continuous thread 105 for the purpose of penetrating into and advancing through a cork 155. The thread 105 is a helical shape, and can be either right-handed or left-handed. The device provides for threads 105 that include a nosecone 30 that has a matching thread with screw body section 15. The nosecone 30 and screw body section 15 meet at an interlock area 110. As will be described in greater detail later in the specification, the nosecone 30 is associated with a lower device assembly and the screw body section 15 is associated with an upper device assembly.

The lower device assembly, beginning with the nosecone 30, includes a tube 80 that depends from the upper end of the nosecone, the tube 80 providing a first lumen 90 therein and terminating with a valve 115. The tube 80 of the lower assembly includes at least one orifice 85 (such as a hole) that provides fluid connection from the lumen 90 within the tube to the outside of the tube. Shown in FIG. 2 the tube 80 is shown with a pair of orifices 85, the second orifice to provide for additional flow area to lumen 90; additional orifices could also be used, as well as a single orifice.

Optionally, the screw body section 15 of the upper assembly extends upward to a section that can include a stopper 100. The stopper functions to couple the device with bottles lacking a cork. A cylindrical opening 32 extends through the screw body section 15 and stopper section 100 of the upper assembly. The upper assembly terminates with seal 75 that provides fluid sealing between the cylindrical opening 32 and the outer diameter of the tube 80. A connection 55 intersects and provides fluid connection with the cylindrical opening 32 to a gas entrance 70 that connects to a gas source. The gas source can be a gas cartridge 65 and can include a regulator 60 for reducing the pressure of the gas cartridge 65 to a lower pressure compatible for use by the device.

A second lumen 95 is created by way of the area between the outer diameter of the tube 80 and the cylindrical opening 32. A collar 130 is provided for selectively clamping to the tube 80 for the purpose of locking the device in a penetrating configuration. To prepare the device for coupling with a bottle, as shown in FIG. 2 the device is in a penetrating configuration where axial movement A as well as rotational movement B between the upper and lower device assemblies is prevented. In this manner, screw nosecone 30 of the lower device assembly and screw body section 15 of the upper assembly provide for a thread 105 for penetrating the cork 155. The screw of the device 105 is introduced to the cork 155 and, through a combination of pressure and rotation of the device relative to the bottle, the device is advanced into and through the cork.

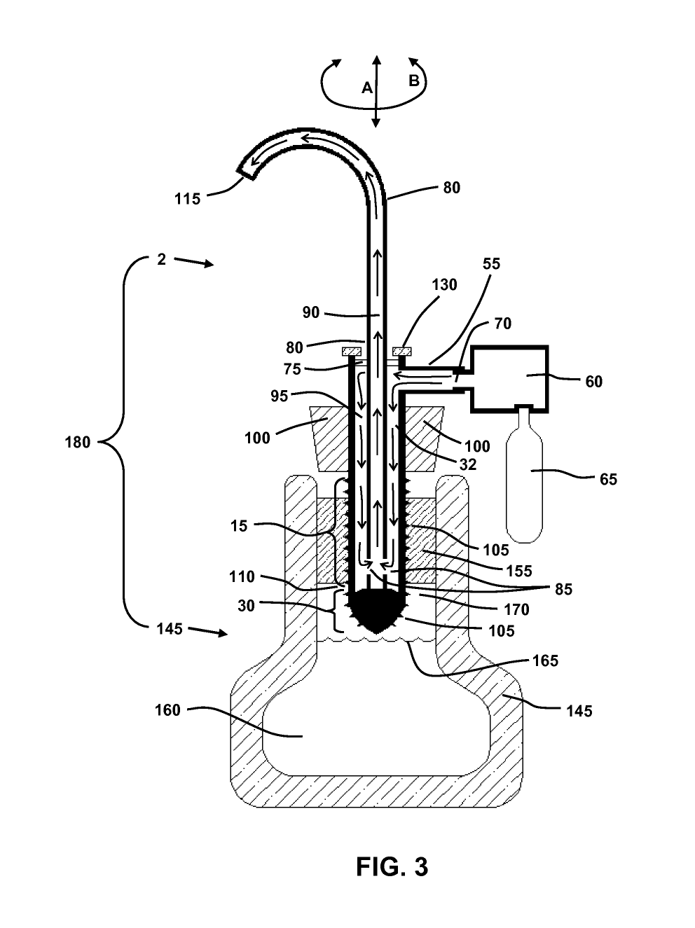

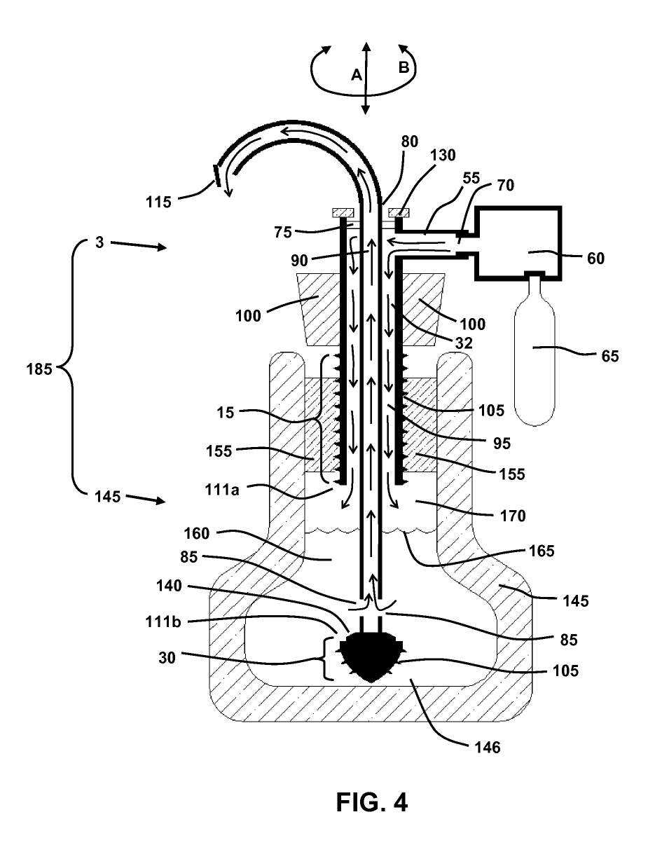

The device 2 and bottle 145 are shown in FIG. 3 with the device coupled to the bottle 180 and with the continuous thread of the device penetrating through the cork 155. The thread of the device 105 is advanced into and through the cork 155 until the nosecone 30 and interlock area 110 are fully within the bottle headspace 170. At that point, the collar 130 can be selectively loosened so the device can be toggled to a dispensing configuration (as will be further reviewed in reference to FIG. 4). The screw body section 15 and the thread 105 thereon are in snug contact with the cork 155 and thus provide fluid-tight sealing between the device and the bottle.

With the device in the penetrating configuration, an optional gas purge can be performed to remove ambient air that may be within lumens 95 and 90 of the device. The flow of gas is indicated by arrows in FIG. 3. The gas can be supplied by any suitable source; in this example, a gas cartridge 65 in cooperation with a regulator 60. The regulator 60 reduces the pressure of the gas cartridge 65 from a high pressure to a lower working pressure suitable for use by the device. To initiate a gas purge, the gas source is turned on (or is connected to the device) and enters the device at a gas entrance 70. Next, the gas enters the second lumen 95 that is created between the cylindrical opening 32 and the tube 80 outer diameter. The gas then enters the first lumen 90 within the tube 80 where the gas is then contained by the valve 115. To complete the purge, valve 115 is opened for a period of time sufficient to allow the gas to remove all of, or the majority of, ambient air contained within the first lumen 90 and second lumen 95 of the device. The gas purge reduces the amount of atmospheric air that the wine within the bottle is exposed to, as will become apparent in the next step where the device is toggled to a configuration for dispensing.

Moving to FIG. 4, the device 3 is shown coupled to the bottle 145 and in a dispensing configuration 185. In preparation for switching the device from the penetration configuration (shown in FIGS. 2-3) to the dispensing configuration (FIG. 4), the collar 130 is selectively loosened. This allows for axial movement A between the upper device assembly and lower device assembly, allowing the nosecone 30 and the tube 80 of the lower assembly to be lowered to be submerged within the wine 160. The tube 80 is of a length to allow sufficient travel for the nosecone 30 to reach the bottom of a bottle 146. As shown in FIG. 4, the orifice 85 is below the wine level 165 within the wine 160, allowing for wine to be in fluid communication with orifice 85.

Following the arrows shown in FIG. 4, in the dispensing configuration 3, gas enters the device at the gas entrance 70 and travels through connection 55 into second lumen 95 created by the area between the cylindrical opening 32 of the upper assembly and the outer diameter of tube 80 of the lower assembly. This allows for gas to be in fluid communication with the head space of the bottle 170 where it builds into a pressure head acting on wine surface 165, thereby allowing the device 3 to create a pressure vessel in combination with bottle 145. When valve 115 is selectively opened, wine 160 is forced into first lumen 90 of the tube 80 by way of orifice 85 (or multiple orifices, as shown in FIG. 4). Wine 160 then moves up the first lumen 90 where it is dispensed from the device at the valve 115. Closing of the valve 115 halts dispensing, and reopening the valve 155 resumes dispensing (as long as a sufficient gas pressure head is maintained, as well as sufficient remaining wine 160).

For most bottle-dispensing conditions, it is desirable to have the orifice 80 in relatively close proximity to the nosecone 30 so that the orifice 80 can be positioned as close as possible to the bottom of the bottle. However, it can also be of benefit to have the orifice 80 offset in the upward direction from the bottom of the bottle, as it can aid in preventing sediment from being dispensed, compared to the orifice being positioned to the very bottom of the bottle (typically, sediment concerns would be related to wine of a significant bottle age).

As the wine is dispensed, and when the level of wine 165 is reduced to the level of the orifice(s) 85, then valve 115 is preferably shut in order to stem unnecessary gas consumption from the gas cartridge 65 or gas source. At this point, the device 3 can be removed from the bottle 145 by following the reverse of the steps to couple with the bottle. The cork can be removed and any remaining wine can be poured in the traditional way. The device and gas cartridge can also be designed so that a single gas cartridge dispenses a corresponding amount approximate a single bottle of wine; in that case, excess gas loss once all wine possible has been dispensed would not be a concern.

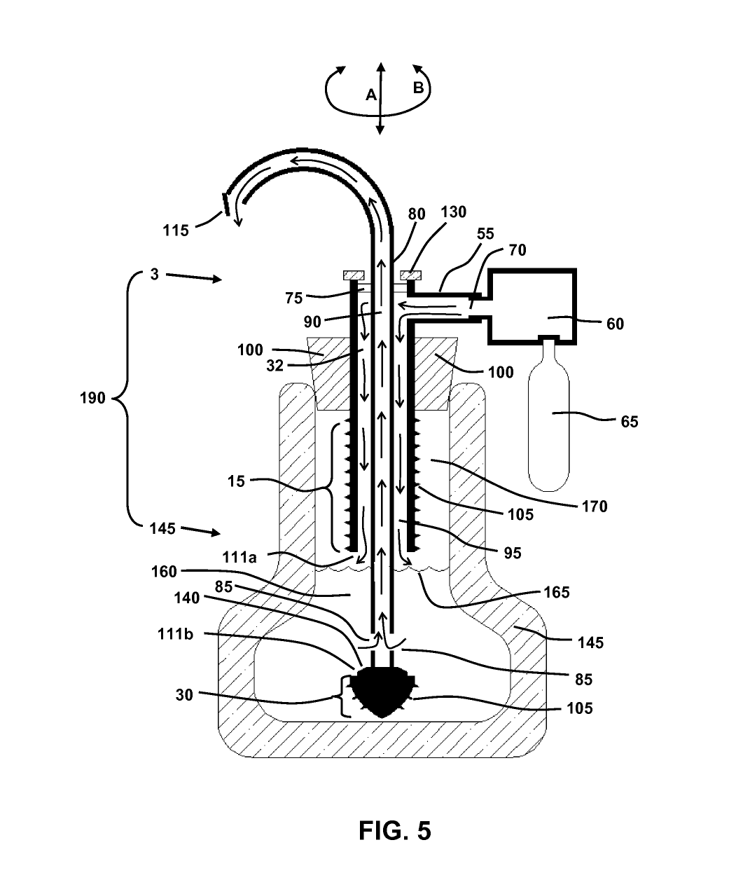

As described in FIG. 4 and FIG. 5 and accompanying text, coupling the device by penetrating through the cork 180 and 185 along with the described gas purge allows for wine to be dispensed and stored with minimal exposure to ambient air. When an inert gas is used, e.g., argon, the device provides for a superior preservation of wine over an extended period of time, allowing a bottle of wine to be enjoyed in small portions over a long period of time and with intermittent time periods between. One important advantage of the device is that it can allow for wine dispensing without removal of the cork; this prevents exposure to air that would typically be experienced when the cork is removed. Based on prototype testing of the invention to date and using this method, it is believed that most wines can reliably be preserved and dispensed with no noticeable, or minimal detrimental change, in taste or bouquet for over a month, and possibly for several months or potentially longer.

However, not all wine bottles have corks; for instance, many wine bottles are now sealed with a screw cap. Still other corks may be of synthetic material as opposed to natural bark cork and can prove difficult to penetrate. In addition, there are times when the desire to save the remainder of the wine is realized at a point in time after a bottle is opened, i.e., after the cork has already been removed and perhaps a portion already dispensed. To address instances where there may not be a cork, or where it is not desirable to penetrate the cork, the device can optionally have stopper 100, which alternatively allows the device to be coupled to bottles lacking a cork.

Shown in FIG. 5 is the device of FIG. 2-4, depicting an alternative way of coupling the device 3 to the bottle 145 by way of stopper 100, which seals against the inner opening of the bottle 145. For this alternative way of coupling the device to the bottle 145, the cork may have previously been removed or the bottle could be of the variety having a screw top or other seal not compatible with penetration by the device/method as described in FIGS. 2 and 3 and accompanying text. As detailed in FIG. 5, the device 3 is shown coupled to the bottle 145 wherein the device is in an extended configuration 190. The stopper 100 of the device upper assembly provides a fluid-tight seal with the inner opening of the neck area of the bottle. The stopper 100 can be a tapered variety, as shown in FIG. 5, where downward pressure is needed to seat the stopper within the bottle neck opening. With this method, and unlike the cork penetration method, the device 3 need not be in a penetrating configuration to couple with the bottle; thus, the device can optionally be left in a dispensing configuration for coupling with the bottle. Similarly to the cork penetration method, the upper assembly including the nosecone 30 and tube 80 can be adjusted in the axial A direction to ensure the nosecone 30 is extended to the bottom of bottles of various heights. As indicated with arrows in FIG. 5, the dispensing of wine 100 follows a similar flow path to that described where the cork is penetrated, and that was described in the detailed description accompanying FIG. 4.

As an alternative to using a stopper 100 having a taper, the stopper can be without a taper. For example, a straight stopper can be used that has a constant outer diameter that is slightly undersized relative to the inner diameter of the bottle neck opening. Then, upon insertion of the straight stopper, compression can be applied that acts on the stopper to expand to thereby seal against the bottle neck opening. The seal can be a rubber packing that is selectively compressed by a screw mechanism, similar to mechanism as described in patent application publication US 2005/0142260, filed Dec. 24, 2003, under application Ser. No. 10/746,929, by Chen et al., entitled “Wine Preservation System” and herein incorporated by reference. As a further alternative, the stopper can have an internal bladder that allows the stopper to expand and seal with the bottle when the bladder is inflated. The same gas source can be used for inflation or a hand pump could be used.

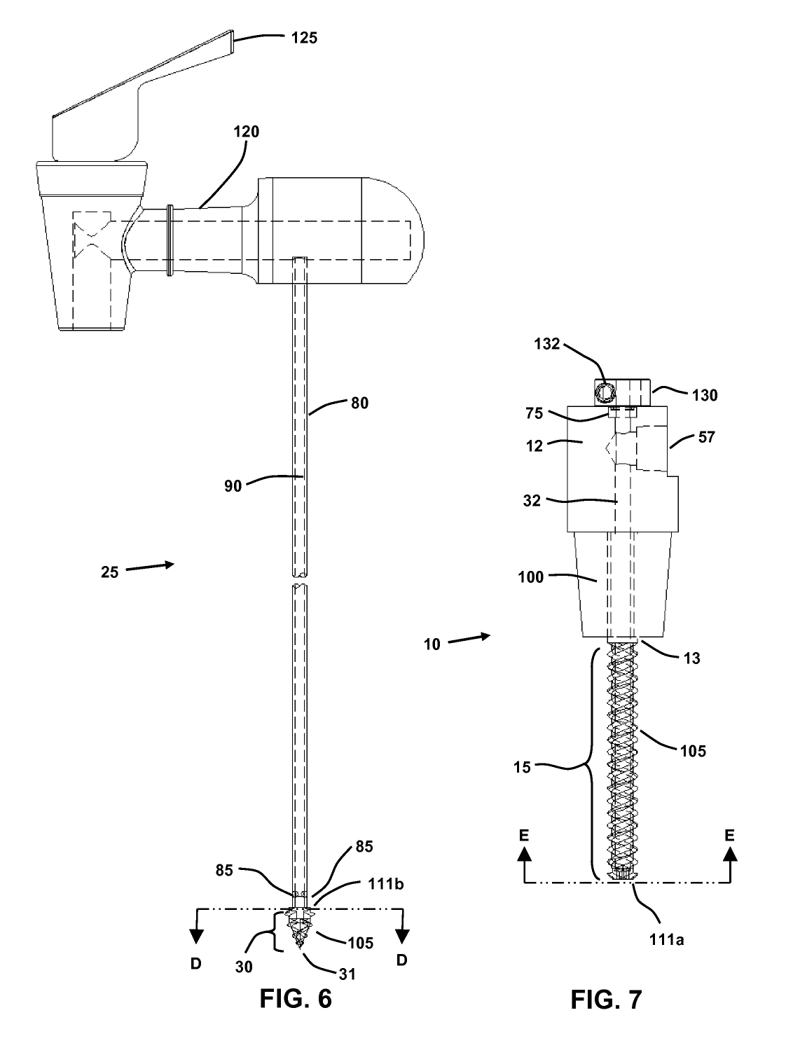

In reference to FIG. 6, the lower device assembly 25 and the upper device assembly 10 shown in FIG. 7 are shown separated from one another to clarify and discuss their respective functional components/features in greater detail. The lower assembly 25 starts with nosecone 30 having a pointed end 31 at the lower end and having a thread 105 on the outer diameter. The upper area of the nosecone 30 has interlock geometry 111b that is complementary in geometry to that of corresponding interlock 111a of upper assembly 10.

A tube 80 extends upward from nosecone 30 and provides a first lumen 90. The tube can be constructed from a polymer or metal; e.g., 304 stainless steel. In order to make the tube less susceptible to being accidently bent and deformed by a user, it can alternatively be constructed of nitinol, or other shape memory alloy exhibiting “superelastic” properties. A tube 80 sized nominally with an outer diameter of .125 inch and an inner diameter of .085 inch has been found to work acceptably for this application; variations from these dimensions can also work acceptably. The tube 80 includes an orifice 85 that can be one or several openings or a plural series of orifices that could be arranged either radially, axially, or both radially and axially. If desired, a plural series of orifices can also be sized corresponding to provide for some level of filtering to prevent or reduce wine sediment from passing. The orifice 85 opening/openings are generally positioned on the tube 85 so they are proximal the nosecone 30. A valve is connected to the tube 80 and provides fluid communication and control of the first lumen 90. As shown by way of one example in FIG. 6, the valve can consist of a spigot 120, the valve of which can be selectively actuated by a lever handle 125. Tomlinson Industries, located in Ohio, has several spigots containing a valve that are examples of spigots of a general design that can be suitable for use with the device.

Switching to the upper assembly 10 of FIG. 7, the upper assembly 10 has a screw body section 15 of a length sufficient to penetrate a typical cork. A length of 2.0 inches has been found to be sufficient to accommodate most corks. The screw body section 15 has a thread 105 to aid the device in penetrating and passing through a cork. The lower end of the upper assembly 10 in this particular embodiment has interlock geometry 111a for mating with that of a corresponding interlock area 111b of the lower device assembly 25. Optionally, the upper assembly 10 can have a stopper 100 in the section of the upper assembly above and proximate the screw body section 15. Above the stopper 100, the upper assembly 10 can have a connection body section 12 that can provide for a connection point 57 for connection to a gas source. The body section 12 can also provide an attachment location for a handle (20 in FIG. 1) and also for a mounting location for the seal 75. Passing through the upper assembly 10 is a cylindrical opening 32. The cylindrical opening 10 is concentric the screw body section 15 and the stopper 100 in this embodiment.

The seal 75 is shown located at the top of the upper assembly 10. The seal 75 provides fluidic sealing between the cylindrical opening 32 and the outside of tube 80 of the lower assembly 25 (when the device is coupled together). The seal 75 can functionally be positioned at any location along the length of the cylindrical opening 32, although it is preferably not positioned within the area of the screw body section 15 in order that the diameter of the screw body section is minimized for reduced trauma to the cork during penetration into and through the cork. The cylindrical opening 32 can include a counter-bored area for receiving the seal 75, and any acceptable retention means known in the art can correspondingly be used for retaining the seal. A seal 75 that can work in this application is the spring-loaded PTFE shaft seal from McMaster-Carr Supply Company of part number 13125K63. A simple O-ring, quad-ring, other seal known in the technology of seals and/or the technology of shaft seals can also be used.

The collar 130 selectively prevents axial movement of the device by applying gripping force to the tube 80 when the lower assembly 25 and the upper assembly 10 are coupled with one another and the device is in a penetrating configuration. The collar 130 can be a one-piece shaft collar that tightened and loosened by means of a setscrew 132; e.g., part number 6435K31 supplied by the McMaster-Carr Supply Company can be used. As shown in FIG. 7, the collar 130 can be attached to the upper assembly 10 in a way that acts to retain the seal 175 within a counterbore opening of the upper assembly body 12. As an alternative, rather than being attached, the collar 130 can be a separate component of the device. When the upper and lower assemblies are coupled, the collar 130 is allowed to slide freely on the tube 80 when in a loosened state, but can be pushed adjacent the upper assembly body 12 by a user and be tightened when the device is in the penetrating configuration to effectively lock the device in the penetrating configuration.

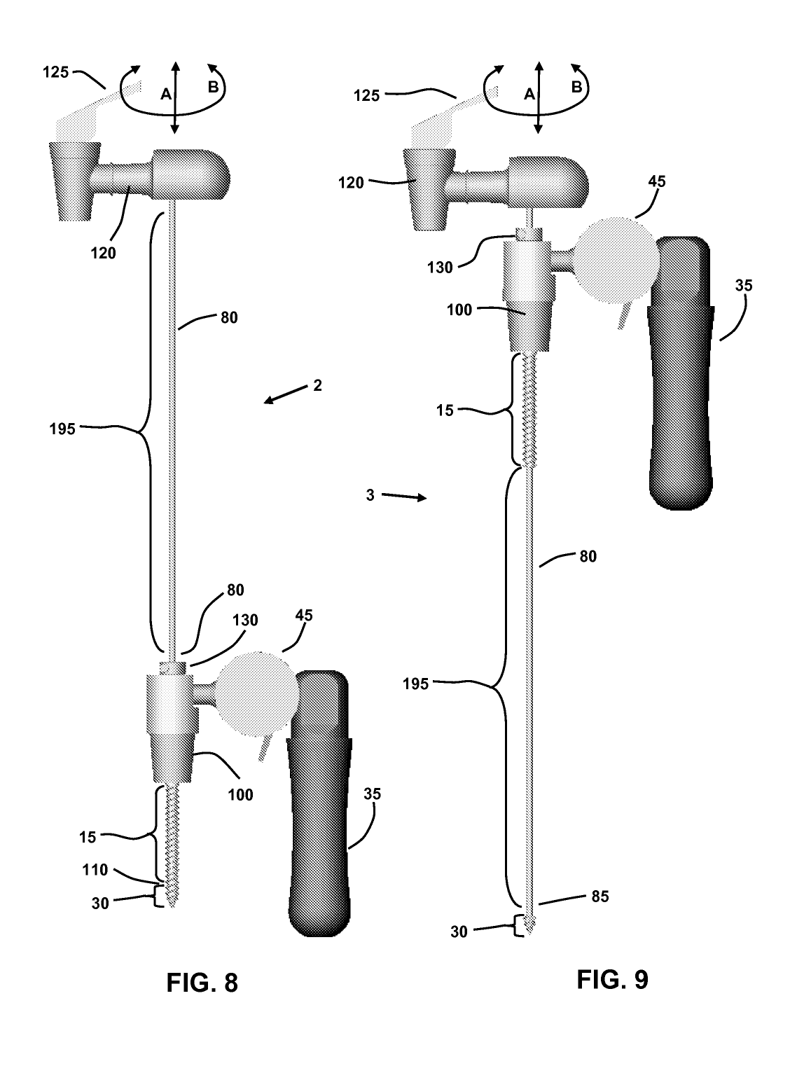

For functional use of the device, the upper device assembly 10 and lower device assembly 25 are in combination with one another, wherein tube 80 of the lower assembly 25 passes through the cylindrical opening 32 of the upper assembly 10. This allows for the lower assembly 25 to be axially movable relative the upper assembly 10 and the lower assembly via the tube 80 is axially moveable within cylindrical opening 32 and seal 75 when the collar 130 is left loosened. This is shown in FIGS. 8 and 9 where the device is shown with the lower device assembly 25 and the upper device assembly 10 in combination.

The lower assembly 25 shown in FIG. 6 and the upper assembly 10 shown in FIG. 7 have been shown and described up to this point with emphasis on the functional aspects of the device. In actual reduction to practice, the device can be constructed in multiple sections of components that are in addition to that shown for manufacturing or assembly considerations. For example, nosecone 30 and screw body section 6 can be constructed as a separate component from tube 80 and body section 12, and later joined. Any number of joining techniques, i.e., brazing, soldering, welding, crimping, interference fit, over-molding, etc., can be used to join the respective components together. The nosecone 30 and screw body section 15 can also be constructed out of any number of metals, plastics, or other materials by way of any number of known manufacturing methods. As a specific example, the nosecone 30 and screw body section 15 can be machined from type 17-4 PH stainless steel via Swiss screw machine turning. Using type 17-4 PH stainless steel can also allow the nosecone 30 and screw body 15 components to be optionally heat treated for precipitate hardening of the components. The nosecone 30 and screw body section 15 can also, optionally, be polished, i.e., electropolished or mechanical polished. Polishing can help to provide lower friction advancement of the components into and through a cork. Additionally, or as an alternative option, the components to be in contact with the cork can be coated with a low friction material, i.e., polytetrafluoroethylene (PTFE), fluorinated ethylene propylene (FEP), nylon, or other low friction material.

The dispensing device is shown in a penetrating configuration in FIG. 8 and in a dispensing configuration in FIG. 9. When in the penetration configuration, the collar 130 can be tightened to prevent axial A movement between the upper and lower assemblies. The collar works together with the interlock area 110 which more directly prevents rotational movement B between the upper and lower assemblies when the interlocks are engaged. With both axial A and rotational B movement locked out, a substantially continuous screw thread is created between the screw body section 15 of the upper assembly and the nosecone 30 of the lower assembly. In this configuration, when initial downward pressure is used in combination with rotation, the device is capable of penetrating into and through a cork, and to do so relatively cleanly.

The collar 130 is released to toggle the device to the dispensing configuration 2. The spigot 120 of the lower assembly can then be manually be pressed downward axially A once the collar is loosened. The available travel 195 of the dispensing device is determined primarily by the length of the tube 80. The travel 195 can allow for adjustability in the ability of the nosecone 30 to reach the bottom of bottles of different depths, such as the general differences in design of bottles that are 750 ML, or to accommodate differences based on volumetric size, e.g., bottles 750 ML vs. 1500 ML. It can be preferable to have the seal positioned near the top of the upper assembly in order to allow for additional play between the tube and the cylindrical opening and therefore allow the nosecone to move to the side of a punt or bottle indentation for dispensing. It can be desirable, as determined by a user, to engage or tighten the collar 130 in order to help prevent axial A and rotational B movement of the spigot 120 during wine dispensing. Keeping the collar 130 tightened can also be preferred if only the stopper 100 of the device is intended to be used for coupling with a bottle.

There are any number of complementary mating geometries that can be used for the respective interlock of the upper assembly 111a and interlock of the lower assembly 111b. A number of screw drive types, or adaptations thereof, can be used as a general basis for the interlock geometry. Some non- limiting examples include slotted, cross, Phillips, Poxidriv®, square, Robertson, hex, hex socket (Allen), Torx®, tri-wing, Torq-set, Spanner head, Triple square, Polydrive, Spline drive, Double hex, Bristol, and Frearson.

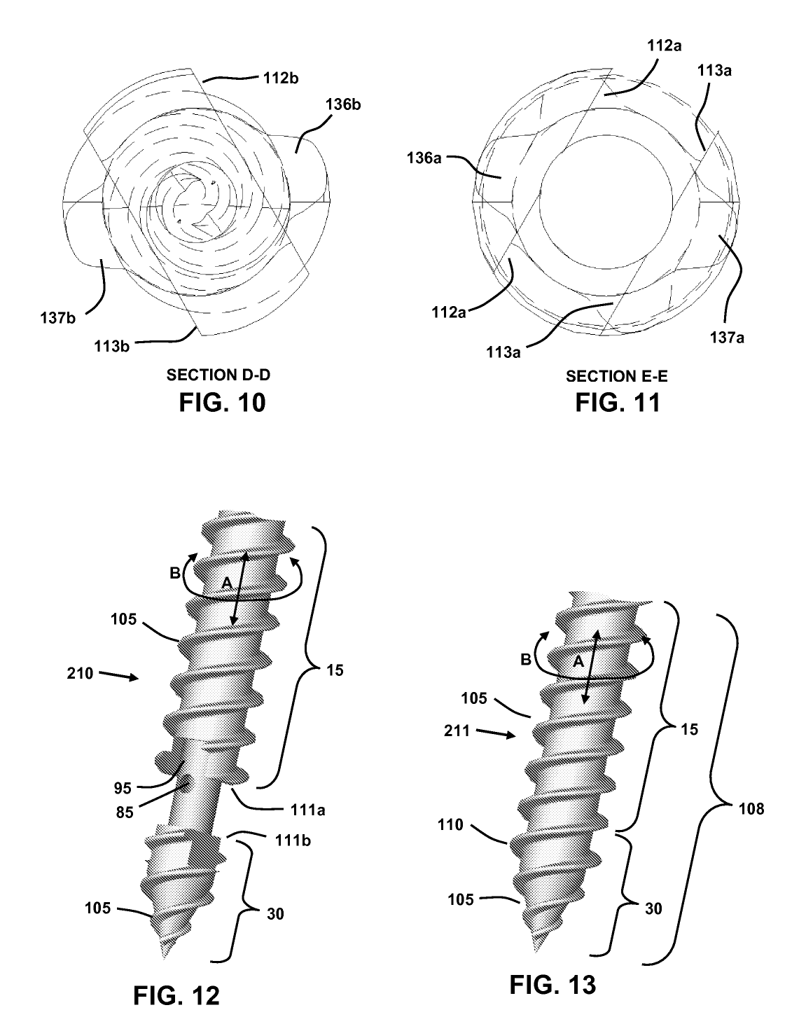

An example of one possible embodiment of the interlock geometry is shown in greater detail for the lower assembly in FIG. 10 that is a section view of D-D from FIG. 6. The corresponding interlock geometry for the upper assembly is shown in the section view of FIG. 11 of section E-E from FIG. 7. This particular embodiment uses a slotted design wherein the respective interlock areas (111a in FIGS. 6 and 111b in FIG. 7) have complementary mating geometry to prevent rotational movement between the upper and lower assemblies when the assemblies are coupled together in the dispensing configuration.

Coupling of the upper and lower assemblies' interlock areas can require the user to rotate the lower assembly relative to the upper assembly while simultaneously applying force to bring the assemblies together, the rotation potentially being needed to align the mating geometry so that the respective interlock surfaces 112b-to-112a and 113b-to-113a are aligned and at which point allowing the mating interlock to be fully seated. Once fully seated, the collar can be tightened to assist in maintaining the interlock as fully seated. The respective threads of the nosecone and screw body assembly are designed so that the thread faces of the lower assembly 136b and 137b are in alignment with the respective thread faces of the upper assembly 136a and 137a. This allows the dispensing device to provide for a thread that is substantially continuous when the interlocks 111a and 111a are mated together. A double thread, or double helix, is used in this embodiment and can be preferable over a single helix to allow a more aggressive thread pitch to reduce the number of rotations needed to penetrate the cork. A double helix is also preferable as it allows for the threads of the upper assembly and lower assembly to mate together and form a continuous thread regardless either of the two possible rotational orientations, 180° apart based on a slot, of the respective mating interlock geometry. Alternatively, a single, triple, etc., helix can also functionally work. A thread with a .220 inch pitch, a .270 inch major diameter, and a .190 inch minor diameter has been found to work acceptably for this application; variations from this can also function acceptably for the device.

FIGS. 12 and 13 show an enlarged view of the lower end of the dispensing device of FIG. 1. The upper and lower screw components are shown in a separated, or partially separated, transition position 210 in FIG. 12. As illustrated by FIG. 12, the first lumen via orifice 85 becomes exposed as nosecone 30 is separated from the screw body 15. Simultaneously, the second lumen 95 also becomes exposed. When the nosecone 30 and the screw body 15 are separated, rotational adjustment B to align the respective interlocks 111a & 111b is likely to be needed prior to all available axial A motion providing full coupling and interlock of the respective components.

FIG. 13 is an enlarged perspective view of the upper and lower components in a penetration configuration. With the device in the penetration configuration 211, the nosecone 30 is adjacent the screw body 15 and the threads 105 of the two components provide a substantially smooth and continuous thread 108, “substantially smooth” being defined by the functional ability to penetrate and advance through a cork seal. Assisting with the ability to penetrate a cork seal in the penetration configuration 211, rotational movement B is prevented by the interlock structure 110 being very close to where the nosecone 30 and screw body 15 abut. This helps provide for maximum rotational rigidity between these two components. As an alternative, it may be possible to rely solely on the tightening of the collar or another structural means to lock out rotational movement sufficient for the nosecone 30 and the screw body 15 to act as a single-threaded body for the purpose of penetrating into and through a cork.

The wine dispensing device can be designed to be compatible with various gas sources and regulator assemblies. The regulator can be a single stage regulator or a multiple stage regulator. The preferred pressure for use by the dispensing device is between 2-10 psi and more preferably between 3-7 psi. In embodiments where the cork is penetrated by the device and that do not have or use a stopper for coupling with the bottle, higher pressures can be used, such as 5-15 psi. The preferred gas is high purity argon, although other gases can also be used. Example regulators and regulator assemblies that can be adapted for use in this application include regulators distributed by Genuine Innovations item numbers 32110 “Regulator Composite Dual Kit” and 32101 “Regulator Composite Kit,” as well as those distributed by Leland Limited Gas Technologies item numbers 50046 “Regulator NR30”, 50048-001 “Regulator NR-24”, and 50043 “Regulator NR-30.” Additionally, regulators supplied by Beswick Engineering of Greenland, N.H., such as three-stage regulator model PRD3HP, may be used, as well as other regulators known in the general technology of regulators.

By way of example, consumable gas cartridges that can be used for this application include argon and nitrogen cartridges supplied by iSi Components GmbH of Austria as wells as those supplied by Nippon Tansan Gas Co. Ltd. of Japan. As shown in FIG. 1, the dispensing device can have a dedicated regulator assembly. As an alternative, the regulator assembly can be selectively coupled and decoupled to the dispensing device as needed for dispensing by adding a valve-supported coupling mechanism to the dispensing device, similar to the coupling mechanism in the incorporated patent application publication reference to Chen. As an additional alternative, a single regulator assembly can provide a gas supply to gangs of dispensing devices, similar to how a single CO₂ tank and regulator are frequently ganged to multiple soda containers in soda fountain that having multiple soda selections. As a safety feature, possibly depending on the level of safety in the regulator assembly itself, a pressure relief valve can be added to the device to help prevent an overpressure condition based on regulator malfunction or due to a desire to have a limit on providing a user direct control over the gas pressure that is inputted into the device.

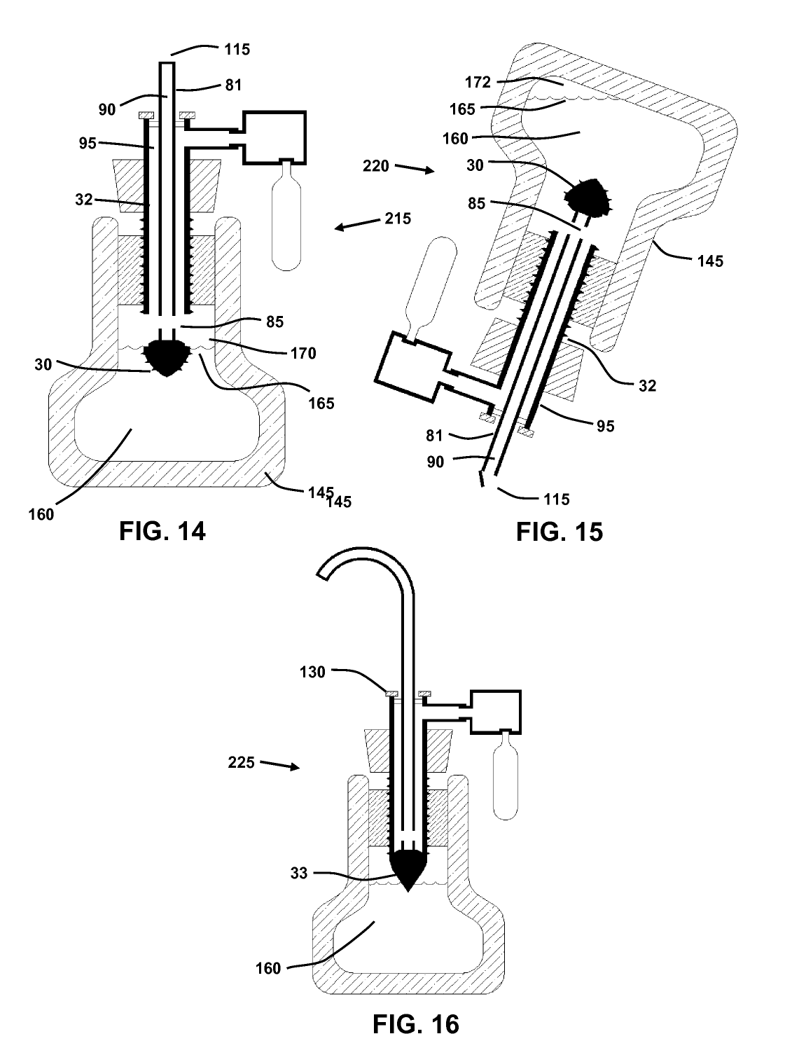

The schematics of an alternative embodiment of the dispensing device are shown in FIGS. 14 and 15. The device in this embodiment is similar to the embodiment of FIGS. 2-5, with the exception that tube 81 is shortened and the valve 115 is positioned for dispensing when the device and bottle is tilted substantially upside down. This embodiment allows for coupling to the bottle via penetrating the cork, or alternatively, by the use of the stopper. An advantage of this embodiment is that it provides a reduction in the dispensing device's overall height as well as providing dispensing that is more similar to traditional pouring from a bottle. When in the dispensing state, the shorter tube 81 does not allow the nosecone to extend to the bottom of the bottle, thus, to facilitate dispensing of the wine 160 requires that the bottle and device be tipped as shown in FIG. 15 so the gaseous head space floats upward to allow the orifice 85 to be in fluid contact with the wine 160. This allows for dispensing of wine 160 when valve 115 is opened. This embodiment can necessitate an orchestration of gas delivery with dispensing. For example, the headspace 170 of the bottle may need to have pressure added when in the upright position 215, and then have the gas turned off during dispensing 220. During dispensing 220, pressure within the headspace 172 is used to dispense wine 160 when valve 115 is opened. Orchestration of gas delivery and beverage dispensation can be accomplished using the first lumen 90 in coordination with the second lumen 95 in a similar manner to that disclosed by Lambrecht in patent application publication US 2005/0178801, filed Dec. 13, 2004, application Ser. No. 11/010,598 entitled “Wine Extraction and Preservation Device and Method,” herein incorporated by reference.

As an alternative embodiment from that shown in FIGS. 2-5 and FIGS. 14 and 15, the function of the first lumen 90 and the second lumen 95 can be swapped with one another. This can provide an advantage for upside down dispensing (220 in FIG. 15) such as simulating pouring from a bottle, the potential advantage being that allowing gas can be dispensed via orifice 85 during dispensing, given that the bubbles from the gas delivery will float towards the headspace 172 without being drawn into the lumen that is then used for dispensing (the second lumen 95). In this way, the gas source can be left on, eliminating any need for coordination of gas delivery with dispensing based on the device bottle orientation (215 & 220).

A further embodiment of the wine dispenser is shown with the device coupled with a bottle 225 in FIG. 16. In this embodiment, a non-threaded nosecone 33 is provided. The non-threaded nosecone provides a simplified design compared to the nosecone having threads, with the trade-off of requiring additional downward force to initiate and advance the device through a cork. This embodiment can also eliminate the need for interlocking structure between the non-threaded nosecone 33 and the screw body section, given that allowing the lower assembly to rotate relative the upper assembly during cork penetration does not prevent penetration and advancement of the device into the cork.

While the preferred embodiment of the dispensing device has been disclosed, various alterations can be made which fall within the scope of the invention. For example, the device can be made with additional or fewer components from that shown in the example embodiments in order to improve manufacturability of the device while still providing for equivalent operational function of the components. Similarly, there are many different materials that can be substituted and used for various reasons in lieu of those disclosed that provide for the same operational function. In addition, it is anticipated that the dispensing device may also work for penetrating seals other than cork and for sealing with other containers; and the dispensing device can also be useful for dispensing liquids other than wine such as other beverages, chemicals, or other industrial or chemical solutions. It should also be recognized that many other existing and known stopper methods can be adapted for use in the design of the stopper portion of the device.

The description of the invention is merely exemplary in nature and, thus, variations that do not depart from the gist of the invention are intended to be within the scope of the invention.

1) A wine dispensing device comprising:
a. an upper and lower device assembly,
(1) the lower assembly comprising:
(a) a screw nosecone having a conical shape section ending in a substantial point, the nosecone having structure defining a first interlock at the opposite end of the pointed end, and the nosecone having a helical thread on at least a portion of the nosecone outer diameter;
(b) a tube, generally concentric with the nosecone and depending from the nosecone on the end having the first interlock area, the tube providing a first lumen therein;
(c) a valve in fluid communication with and capable of controlling flow for the first lumen; and
(d) the tube wall intersected by an orifice located in-between the nosecone and the valve, the orifice providing fluid connection from the outside of the tube to the first lumen,
(2) the upper assembly comprising:
(a) a screw body section having a helical thread, the screw body section being of sufficient length to penetrate the length of a cork and the screw body section having structure defining a second interlock at the lower end of the screw section;
(b) the upper assembly having structure defining a cylindrical opening that extends therethrough the upper assembly, the cylindrical opening being generally concentric the upper assembly and being sized larger than the tube diameter of the lower assembly;
(c) a seal positioned generally concentric the cylindrical opening; and
(d) a connection intersecting and in fluid communication with the cylindrical opening, the connection located in- between the second interlock area and the seal,
(3) the tube of the lower assembly being of greater length than the upper assembly cylindrical opening length; and
(4) the cylindrical opening of the upper assembly being sized larger than the tube outer diameter of the lower assembly,
b. the lower and upper assembly in combination with one another wherein the tube of the lower assembly being generally concentrically positioned within the cylindrical opening of the upper assembly, providing for axial movement between the lower and upper assemblies, and thereby providing a second lumen in the area between the cylindrical opening and the tube outer diameter;
c. the axial movement and rotational alignment providing for a first penetrating configuration and a second dispensing configuration;
d. the first and second interlock areas having complementary mating geometry sufficient to prevent rotational movement between the lower assembly and the upper assembly when the device is in the penetrating configuration;
e. the nosecone thread of the lower assembly and the screw body thread of the upper assembly providing a substantially continuous thread when the device is in the penetrating configuration with the first and second interlocking geometry engaged;
f. the seal providing sealing between the cylindrical opening of the upper assembly and the tube outer diameter of the lower assembly;
g. the orifice located on the tube of the lower assembly providing the orifice to be exposed from the upper assembly when the device is in the dispensing configuration and the orifice to be within the cylindrical opening of the upper assembly when the device is in the penetrating configuration;
h. the tube length being further sized to allow the nosecone to extend into the bottle when the device is in the dispensing configuration; and
i. a collar for selectively locking the device in the penetrating configuration.

2) The device as in claim 1 wherein the upper assembly has a stopper above the screw body section for coupling with a wine bottle neck wherein the bottle seal has been removed and for providing a fluid seal between the upper assembly and the bottle neck.

3) The stopper as in claim 2 wherein the stopper has a taper, the stopper taper being sized to couple to and seal bottle necks having an opening diameter between .650 inch and .780 inch.

4) The stopper as in claim 2 wherein the stopper is an expanding stopper wherein the stopper fits within bottle necks having an opening of between .650 inch and .780 inch and wherein, upon selectable compression of the stopper, the stopper expands to seal the bottle neck.

5) The wine dispensing device as in claim 1 wherein the device further comprises a gas source coupled to the device, the gas source being injected at the connection point and wherein wine is capable of being dispensed out of the tube when the valve is opened.

6) The wine device as in claim 5 wherein the gas source is coupled to the upper assembly and wherein the gas source rotates along with the device when penetrating a bottle cork, the gas source consisting of a regulator in combination with a gas cartridge, the cartridge having a starting cartridge pressure of between 1000 to 3000 PSI and wherein the regulator reduces the gas cartridge pressure to a working pressure between 3 to 15 PSI to be provided to the device connection point.

7) The gas source as in claim 5 wherein the gas pressure to be provided to the device connection point is between 3 to 15 PSI.

8) The gas source as in claim 5 wherein the gas source comprises at least 99.5% argon.

9) The wine dispensing device as in claim 1 wherein the tube being constructed of an alloy having superelastic properties.

10) The wine dispensing device as in claim 1 wherein the lower assembly being capable of allowing the nosecone to extend off axis of the dispensing device when in the dispensing configuration wherein the nosecone being able to extend to the bottom of the bottle by extending to the side of a punt of the bottle.

11) The wine dispensing device as in claim 1 wherein the upper assembly further comprises a handle for rotational penetration and advancement of the continuous thread when the device is in the penetrating configuration.

12) The wine dispensing device as in claim 1 further comprising a pressure relief valve.

13) The wine dispensing device as in claim 1 wherein the valve is at the terminal end of the first lumen where dispensing occurs.

14) The wine dispensing device as in claim 1 wherein the tube has a second orifice, or further plurality of orifices.

15) The wine dispensing device as in claim 1 wherein the thread of the lower assembly and the screw body thread of the upper assembly consist of a double helix thread.

16) The wine dispensing device of claim 1 wherein the outer diameter of the tube being between .095 and .155 inch.

17) The wine dispensing device as in claim 1 wherein the thread of the lower assembly and the screw body thread of the upper assembly being coated with polytetrafluoroethylene.

18) A wine dispensing device comprising:
a. an upper and lower device assembly;
(1) the lower assembly comprising:
(a) a screw nosecone having a conical shape section ending in a substantial point, the nosecone having structure defining a first interlock at the opposite end of the pointed end, and the nosecone having a helical thread on at least a portion of the nosecone outer diameter;
(b) a tube, generally concentric with the nosecone and depending from the nosecone on the end having the first interlock area, the tube providing a first lumen therein;
(c) a valve in fluid communication with and capable of controlling flow for the first lumen; and
(d) the tube wall intersected by an orifice located in-between the nosecone and the valve, the orifice providing fluid connection from the outside of the tube to the first lumen,
(2) the upper assembly comprising:
(a) a screw body section having a helical thread, the screw body section being of sufficient length to penetrate the length of a wine bottle seal and the screw body section having structure defining a second interlock at the lower end of the screw section;
(b) the upper assembly having structure defining a cylindrical opening that extends in therethrough the upper assembly, the cylindrical opening being generally concentric the upper assembly and being sized larger than the tube diameter of the lower assembly;
(c) a seal positioned generally concentric the cylindrical opening; and
(d) a connection intersecting and in fluid communication with the cylindrical opening, the connection located in-between the second interlock area and the seal,
(3) the tube of the lower assembly being of greater length than the upper assembly cylindrical opening length; and
(4) the cylindrical opening of the upper assembly being sized larger than the tube outer diameter of the lower assembly,
b. the lower and upper assembly in combination with one another wherein the tube of the lower assembly being generally concentrically positioned within the cylindrical opening of the upper assembly, providing for axial movement between the lower and upper assemblies, and thereby providing a second lumen in the area between the cylindrical opening and the tube outer diameter;
c. the axial movement and rotational alignment providing for a first penetrating configuration and a second dispensing configuration;
d. the first and second interlock areas having complementary mating geometry sufficient to prevent rotational movement between the lower assembly and the upper assembly when the device is in the penetrating configuration;
e. the nosecone thread of the lower assembly and the screw body thread of the upper assembly providing for a substantially continuous thread when the device is in the penetrating configuration with the first and second interlocking geometry engaged;
f. the seal providing sealing between the cylindrical opening of the upper assembly and the tube outer diameter of the lower assembly;
g. the orifice located on the tube of the lower assembly providing the orifice to be exposed from the device when in the dispensing configuration and the orifice to be within the cylindrical opening of the upper assembly when the device is in the penetrating configuration;
h. the tube length being further sized to allow the nosecone to be positioned in the bottle headspace of the bottle when the bottle is full of wine, the dispensing configuration thereby further characterized by necessitating that the device be turned substantially upside down when coupled to the bottle to facilitate dispensing the wine; and
i. a collar for locking the device when in the penetrating configuration.

19) A wine dispensing device comprising:
a. an upper and lower device assembly in combination and being axially toggleable between a first penetrating configuration and a second dispensing configuration;
b. a means for locking the device in the penetrating configuration;
c. the lower assembly comprising:
(1) a nosecone ending in a substantial point;
(2) a tube, generally concentric with the nosecone and depending from the nosecone on the end opposite of the point, the tube providing a first lumen therein;
(3) a valve in fluid communication with and capable of controlling flow for the first lumen; and
(4) the tube wall intersected by an orifice located in-between the nosecone and the valve, the orifice providing fluid connection from the outside of the tube to the first lumen,
d. the upper assembly comprising:
(1) a screw body having a helical thread, the screw body being of sufficient length to penetrate the length of a wine bottle seal and being shorter in length than the tube;
(2) the upper assembly having structure defining a cylindrical opening that extends therethrough, being generally concentric the upper assembly, and the cylindrical opening being sized larger than the tube diameter of the lower assembly, thereby providing a second lumen in the area between the cylindrical opening and the tube outer diameter;
(3) a seal providing sealing between the cylindrical opening of the upper assembly and the tube outer diameter of the lower assembly; and
(4) a connection point intersecting and in fluid communication with the cylindrical opening, the connection point being suitable for introduction of a gas,
wherein the orifice located on the tube of the lower assembly is contained within the cylindrical opening of the upper assembly when the device is in the first penetrating configuration and the orifice is exposed from the upper assembly when the device is in the second penetrating configuration.

20) The wine dispensing device of claim 19 wherein the outer diameter of the tube being between .095 and .155 inch.
